(19) United States
(12) Patent Application Publication
(10) Pub. No.: US 2015/0355004 A1
(43) Pub. Date: Dec. 10, 2015

(54) ULTRASONIC FLOWMETER AND ULTRASONIC FLOWMETER ATTACHING METHOD

(71) Applicant: Azbil Corporation, Tokyo (JP)

(72) Inventor: Tomohito HAYASHI, Tokyo (JP)

(73) Assignee: AZBIL CORPORATION, Tokyo (JP)

(21) Appl. No.: 14/730,431

(22) Filed: Jun. 4, 2015

(30) Foreign Application Priority Data
Jun. 5, 2014 (JP) 2014-116991

(51) Int. Cl. G01F 1/66

(52) U.S. Cl. CPC G01F 1/662

(57) ABSTRACT

In a method for attaching an ultrasonic flowmeter, the ultrasonic flowmeter includes: a first and second ultrasound transceiving portions for sending and receiving ultrasound, disposed on outer peripheries of upstream and downstream sides of a pipe, respectively, which has a fluid flowing therein; a flow rate calculating portion for calculating a flow rate of the fluid based on the time periods until the receptions, by the second and first ultrasound transceiving portions, of ultrasound transmitted from the first and second ultrasound transceiving portions, respectively; and an ultrasound absorbing body for absorbing a piping-propagated wave of the ultrasound, attached to an outer periphery of the pipe. The first and second ultrasound transceiving portions are pressed against the pipe, with the ultrasound absorbing body interposed therebetween, through the application of a pressing force from the outside, with the ultrasound absorbing body interposed between the first and second ultrasound transceiving portions and the pipe.

### CROSS REFERENCE TO RELATED APPLICATION

This application claims priority under 35 U.S.C. §119 to Japanese Patent Application No. 2014-116991, filed on Jun. 5, 2014, the entire content of which being hereby incorporated herein by reference.

### FIELD OF TECHNOLOGY

The present invention relates to an ultrasonic flowmeter and an ultrasonic flowmeter attaching method.

### BACKGROUND

Conventionally ultrasonic flowmeters for measuring flow rates of various types of fluids have been proposed and reduced to practice. At present there have been proposals for clamp-on type differential propagation time method ultrasonic flowmeters wherein one pair (or multiple pairs) of ultrasonic transceivers is disposed on outer walls of piping through which a fluid flows, with ultrasonic oscillators in angled wedges, to measure the respective propagation times when ultrasound is caused to pass through the fluid in the direction of flow and in the direction opposite of the flow, to calculate the flow rate of the fluid based on the difference in these propagation times.

In clap-on ultrasonic flowmeters of the type that use the differential propagation time method, it is necessary to provide a damping member (an ultrasound absorbing material) on the outer periphery of the piping in order to suppress the noise that is the signal that propagates through the piping (that part of the ultrasound that is produced by the ultrasonic oscillator that is reflected by the pipe wall of the piping to propagate through the piping). In recent years there have been proposals for methods for attaching arc-shaped damping members to pipes. See, for example, U.S. Pat. Nos. 6,626,049 and 7,000,485.

Note that in ultrasonic flowmeters for measuring gases measurements of gas flow rates at low pressures are required. Because when the pressure of the gas that is subject to measurement is low, the energy of the transmitted signal component is also small, when there are noise attenuating effects through a damping member there is the need to have, for example, the ultrasonic signal be transmitted between oscillators through the placement and securing of the ultrasound transceiving portions.

Here the attachment of the damping member to the pipe and the securing of the oscillator must be determined while ascertaining whether or not the ultrasonic signal that is sent and received by the oscillators through the pipe will be adequate. This is because while, to some degree, the transceiving positions for the ultrasound can be calculated using the pipe dimensions, there are also effects such as those of the states of the internal and external surfaces of the pipe, the characteristics of the materials, and the like.

Because of this, in a conventional ultrasonic flowmeter attaching operation, as illustrated in FIG. 5, it is necessary to execute sequentially the various steps of: (1) attaching a damping member 200 to the pipe 100; (2) cutting away an oscillator attaching part 210 of the damping member 200; (3) coating with a couplant material 300 in order to increase the strength of signal transmission to the oscillator; and (4) attaching an oscillator 400 using a securing member. If, after this the signal strength is inadequate, it is necessary to repeat again starting with step (2).

However, when it is necessary to go through complex steps, such as described above, in the attaching operation, there is a problem in that this cancels out the benefits of the clamp-on type ultrasonic flowmeter wherein the operations for attaching and removing our easy due to there being no need for, for example, operations wherein the pipe has to be cut. Moreover, when complex steps, such as described above, are executed when attaching an ultrasonic flowmeter to a pipe that is positioned here to the ceiling, one must consider what happens if the oscillator or securing member, which are heavy, is dropped, so there are concerns regarding safety as well.

The present invention was created in contemplation of this situation, and an aspect thereof is to simplify the operations for attaching an ultrasonic flowmeter to a pipe, and to simplify the maintenance operations, with a structure that secures the transmission and reception of the ultrasonic signals for the ultrasonic flowmeter.

### SUMMARY

In a method for attaching an ultrasonic flowmeter according to the present invention, the ultrasonic flowmeter includes: a first ultrasound transceiving portion for carrying out transmission and reception of ultrasound, provided on the outer periphery of an upstream side of piping wherein a fluid is flowing; a second ultrasound transceiving portion for carrying out transmission and reception of ultrasound, provided on an outer periphery of a downstream side of the piping; a flow rate calculating portion for calculating a flow rate of the fluid based on the time until the reception, by the second ultrasound transceiving portion, of the ultrasound transmitted by the first ultrasound transceiving portion and the time until the reception, by the first ultrasound transceiving portion, of the ultrasound transmitted by the second ultrasound transceiving portion; and an ultrasound absorbing body for absorbing a piping-propagated wave of the ultrasound, provided on an outer periphery of the piping. The method includes: a placing step for disposing the ultrasound absorbing body between the ultrasound transceiving portion and the pipe; and a pressing step for pressing the ultrasound transceiving portion against the pipe, with the ultrasound absorbing body interposed therebetween, through the application of a pressing force toward the pipe from the outside of the ultrasound transceiving portion.

An ultrasonic flowmeter according to the present invention includes: a first ultrasound transceiving portion that carries out transmission and reception of ultrasound, provided on the outer periphery of an upstream side of piping wherein a fluid is flowing; a second ultrasound transceiving portion that carries out transmission and reception of ultrasound, provided on an outer periphery of a downstream side of the piping; a flow rate calculating portion that calculates a flow rate of the fluid based on the time until the reception, by the second ultrasound transceiving portion, of the ultrasound transmitted by the first ultrasound transceiving portion and the time until the reception, by the first ultrasound transceiving portion, of the ultrasound transmitted by the second ultrasound transceiving portion; and an ultrasound absorbing body that absorbs a piping-propagated wave of the ultrasound, provided on an outer periphery of the piping. The ultrasound transceiving portion is secured through being pressed against the pipe, with the ultrasound absorbing body interposed therebetween, through the application of a pressing force, toward the pipe, from the outside of the ultrasound transceiving portion, in a state wherein the ultrasound absorbing body is disposed between the ultrasound transceiving portion and the pipe.

When this structure is used, the ultrasound transceiving portion can be secured through pressing against the pipe with the ultrasound absorbing body interposed therebetween, through applying a pressing force toward the pipe from outside of the ultrasound transceiving portion in a state wherein the ultrasound absorbing body is interposed between the ultrasound transceiving portion and the pipe. This makes it possible to eliminate the complex operation, which has been required conventionally, when securing an ultrasound transceiving portion to the pipe (such as, for example, an operation for cutting away a portion of the ultrasound absorbing body, an operation for coating the cut part with a couplant material, and the like), thus making the operations for attaching, and removing and adjusting, the first ultrasound transceiving portion substantially easier. As a result, the benefits of the clamp-on ultrasonic flowmeter, wherein there is no need, for example, to cut the pipe, are no longer canceled out. Moreover, this makes it possible to eliminate the complex operation is that have been required conventionally when securing the first ultrasound transceiving portion to the pipe, thus enabling even attachment to a pipe that is disposed near the ceiling to be carried out safely. Furthermore, this enables the ultrasound transceiving portion to be removed easily when changing the positioning of the ultrasound transceiving portions when optimizing fluid measurement or in operations for swapping if an ultrasound transceiving portion becomes damaged, thereby making it possible to simplify maintenance work.

Note that the function for attenuating the piping-propagated wave is achieved through the piping-propagated wave passing through the ultrasound absorbing body and being repetitively reflected and absorbed by the absorbing body. At this time, the inventor discovered that it is possible to ensure the ultrasonic signal, as an ultrasonic flowmeter, when the ultrasound passes through the pipe and the fluid, without repetitively being reflected and absorbed, through disposing an ultrasound absorbing body that is secured between the ultrasound transceiving portion and the pipe, between an ultrasound transceiving portion that is attached facing a pipe. The present invention can effectively utilize the performance of this ultrasound absorbing body.

In the ultrasonic flowmeter according to the present invention, an ultrasound absorbing body that includes a non-cross-linked butyl rubber or a silicone rubber may be used.

When the structure is used, an easily handled material (for example, and non-cross linked butyl rubber or silicone rubber) is employed, making the attaching operation is substantially easier. Furthermore, the non-cross-linked butyl rubber or silicone rubber has relatively high ultrasound transmission performance, making it possible to produce a signal strength that is in no wise inferior to that of the case wherein the couplant agent is employed.

In the ultrasonic flowmeter according to the present invention, an ultrasound absorbing body that includes particles made of tungsten, barium sulfate, iron oxide, and/or alumina may be used.

When the structure is used, an ultrasound absorbing body that includes particles made from a material with high density (tungsten, barium sulfate, iron oxide, or alumina) is employed, making it possible to cause the acoustic impedance of the ultrasound absorbing body to be near to the acoustic impedance of the pipe. The result is the ability to include the transmission performance of the ultrasound absorbing body.

The present invention makes it possible to simplify the operations for attaching an ultrasonic flowmeter to a pipe, and to simplify the maintenance operations, with a structure that secures the transmission and reception of the ultrasonic signals for the ultrasonic flowmeter.

### BRIEF DESCRIPTIONS OF THE DRAWINGS

FIG. 1 is a structural diagram illustrating schematically a structure for an ultrasonic flowmeter according to an example according to the present invention.

FIG. 2 is an enlarged cross-sectional diagram for explaining the structure of a first ultrasound transceiving portion of the ultrasonic flowmeter illustrated in FIG. 1.

FIG. 3 is an explanatory diagram for explaining a method for calculating the flow rate of gas that flows within the piping, using the ultrasonic flowmeter illustrated in FIG. 1.

FIG. 4 is an explanatory diagram for explaining the state of reception, by a second ultrasound transceiving portion, of ultrasound that is transmitted from the first ultrasound transceiving portion of the ultrasonic flowmeter illustrated in FIG. 1.

FIG. 5 is an explanatory diagram for explaining the operation for attaching a conventional ultrasonic flowmeter.

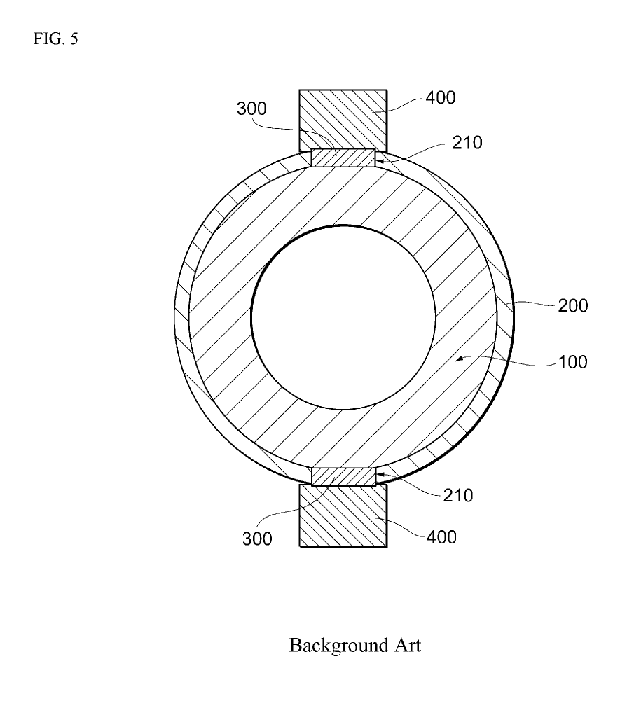

### DETAILED DESCRIPTION

Examples of the present invention will be explained in detail below while referencing the drawings. In the descriptions of the drawings below, identical or similar parts are expressed by identical or similar codes. Note that the drawings do not express the actual dimensions, and specific dimensions, and the like, should be determined in light of the explanations below. Furthermore, even within these drawings there may, of course, be portions having differing dimensional relationships and proportions. Moreover, in the explanations below the top of the figure shall be defined as “up,” the bottom of the figure shall be defined as “down,” the left side of the figure shall be defined as “left,” and the right side of the figure shall be defined as “right.”

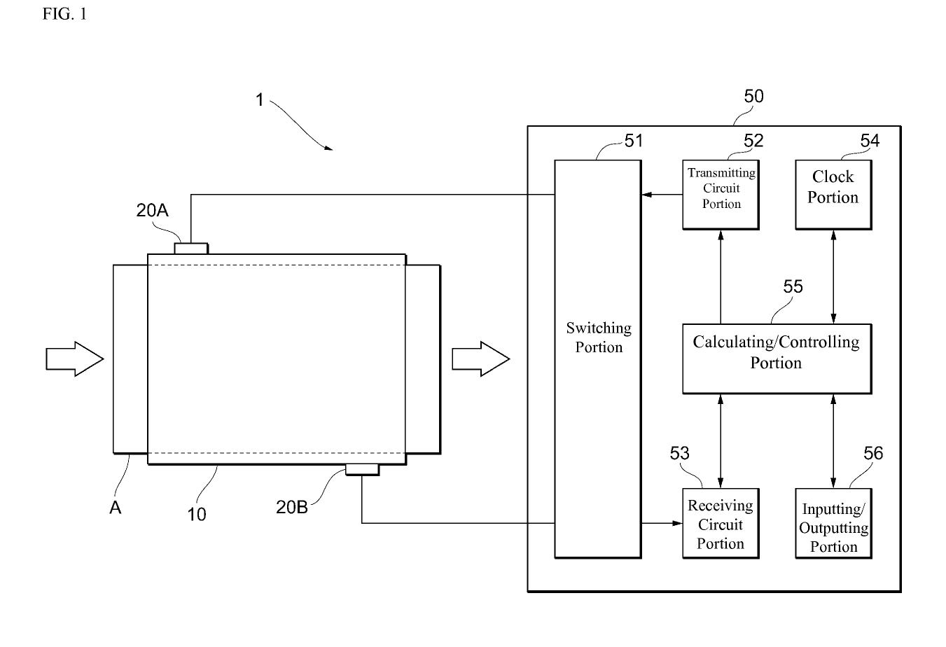

The structure of an ultrasonic flowmeter 1 according to an example according to the present invention will be explained first using FIG. 1 through FIG. 4. The ultrasonic flowmeter 1 according to the present example, as illustrated in FIG. 1, is for measuring the flow rate of air (a gas) that flows within a pipe A. The gas, which is that which is subject to measurement by the ultrasonic flowmeter 1, flows in the direction indicated by the white arrow in FIG. 1 (the left-to-right direction in FIG. 1). The ultrasonic flowmeter 1 is provided with a first ultrasound transceiving portion 20A, a second ultrasound transceiving portion 20B, a main unit portion 50, and an ultrasound absorbing body 10.

The first ultrasound transceiving portion 20A and the second ultrasound transceiving portion 20B are each provided on the outer periphery of the pipe A. In the example illustrated in FIG. 1, the first ultrasound transceiving portion 20A is disposed on the upstream side on the pipe A and the second ultrasound transceiving portion 20B is disposed on the downstream side on the pipe A. The first ultrasound transceiving portion 20A and the second ultrasound transceiving portion 20B each carry out transmission and reception of ultrasound, to transmit ultrasound to each other and receive ultrasound from each other. That is, the ultrasound that is transmitted from the first ultrasound transceiving portion 20A is received by the second ultrasound transceiving portion 20B, and the ultrasound transmitted by the second ultrasound transceiving portion 20B is received by the first ultrasound transceiving portion 20A.

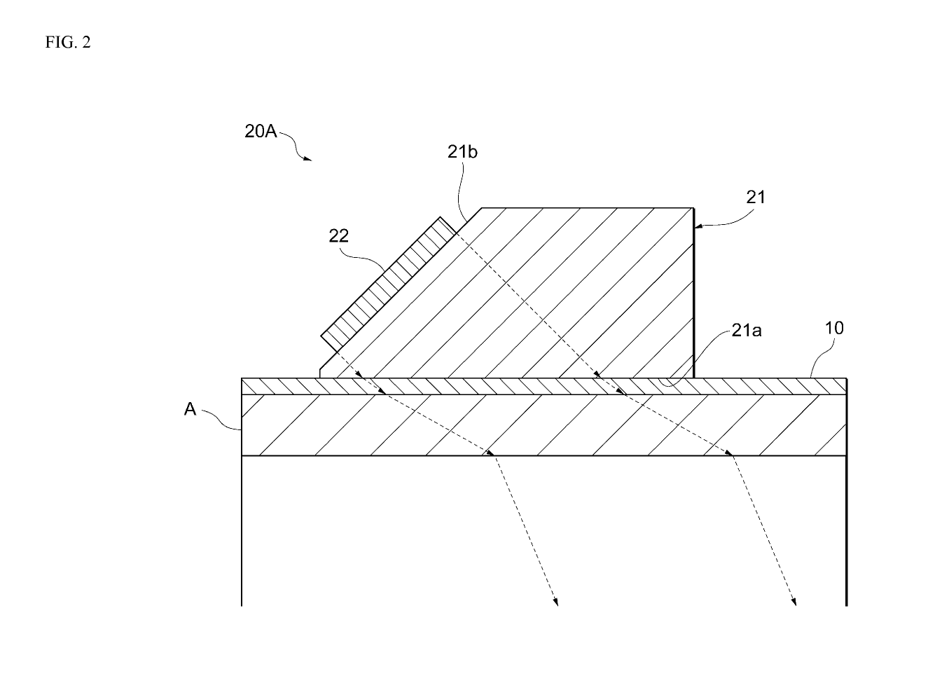

The first ultrasound transceiving portion 20A, as illustrated in FIG. 2, is provided with a wedge 21 and a piezoelectric element 22.

The wedge 21 is for injecting ultrasound at a prescribed acute angle into the pipe A, and is a member that is made out of resin or metal. In the wedge 21, the bottom face 21a is positioned so as to contact an outer peripheral surface of the ultrasound absorbing body 10. Moreover, in the wedge 21 an angled face 21b is formed having a prescribed angle relative to the bottom face 21a. The piezoelectric element 22 is provided in this angled face 21b.

The piezoelectric element 22 both transmits ultrasound and also receives ultrasound. The piezoelectric element 22 is connected electrically by lead lines (not shown). When an electric signal of a prescribed frequency is applied through the lead lines, the piezoelectric element 22 vibrates at the prescribed frequency to emit ultrasound. Ultrasound is transmitted thereby. As illustrated by the dotted arrow in FIG. 2, the ultrasound that is transmitted by the piezoelectric element 22 propagates through the wedge 21 at the angle of the angled face 21b. The ultrasound that passes through the wedge 21 is diffracted at the interface between the wedge 21 and the ultrasound absorbing body 10, and at the interface between the ultrasound absorbing body 10 and the outer wall of the pipe A, to change the angle of incidence, and is also refracted at the interface between the inner wall of the pipe A and the gas that flows within the pipe A, changing the angle of incidence again, and propagates through the gas. The refraction at the interface follows Snell's law, where the angle of the angled face 21b is set in advance based on the speed of the ultrasound when propagating through the pipe A and the speed of the ultrasound when propagating through the gas, to enable the ultrasound to be incident into the gas at a desired angle of incidence, to propagate therein.

On the other hand, when the ultrasound reaches the piezoelectric element 22, the piezoelectric element 22 vibrates at the frequency of the ultrasound to produce an electric signal. The ultrasound is received in this way. The electric signal produced by the piezoelectric element 22 passes through the lead lines to be detected by the main unit portion 50, described below.

Note that the second ultrasound transceiving portion 20B is provided with a structure that is similar to that of the first ultrasound transceiving portion 20A. That is, the second ultrasound transceiving portion 20B is also provided with a wedge 21 and a piezoelectric element 22. Because of this, the detailed explanation of the second ultrasound transceiving portion 20B is omitted, based on the explanation of the first ultrasound transceiving portion 20A, set forth above.

At the main unit portion 50, illustrated in FIG. 1, is for measuring the flow rate of the gas based on the time of propagation of the ultrasound through the gas that flows within the pipe A. The main unit portion 50 is provided with a switching portion 51, a transmitting circuit portion 52, a receiving circuit portion 53, a clock portion 54, a calculating/controlling portion 55, and an inputting/outputting portion 56.

The switching portion 51 is for switching between transmitting and receiving the ultrasound. The switching portion 51 is connected to the first ultrasound transceiving portion 20A and the second ultrasound transceiving portion 20B. The switching portion 51 may be structured including, for example, a switching switch. The switching portion 51 switches the switching switch based on a control signal inputted from the calculating/controlling portion 55, to connect either the first ultrasound transceiving portion 20A or the second ultrasound transceiving portion 20B to the transmitting circuit portion 52, and to connect the other one, of the first ultrasound transceiving portion 20A and the second ultrasound transceiving portion 20B, to the receiving circuit portion 53. This makes it possible to transmit ultrasound from either the first ultrasound transceiving portion 20A for the second ultrasound transceiving portion 20B, and to receive ultrasound through the other one of the first ultrasound transceiving portion 20A and the second ultrasound transceiving portion 20B.

The transmitting circuit portion 52 is for causing the first ultrasound transceiving portion 20A and the second ultrasound transceiving portion 20B to transmit ultrasound. The transmitting circuit portion 52 may be structured through, for example, an oscillating circuit for generating a square wave of a prescribed frequency, and a driving circuit for driving the first ultrasound transceiving portion 20A and the second ultrasound transceiving portion 20B. The transmitting circuit portion 52 outputs, to the piezoelectric element 22 of either the first ultrasound transceiving portion 20A more the second ultrasound transceiving portion 20B, a driving signal that is a square wave that the driving circuit generates through the oscillating circuit, based on a control signal that is inputted from the calculating/controlling portion 55. As a result, the piezoelectric element 22 of either the first ultrasound transceiving portion 20A or the second ultrasound transceiving portion 20B is driven so that the piezoelectric element 22 transmits ultrasound.

The receiving circuit portion 53 is for detecting the ultrasound that is received by the first ultrasound transceiving portion 20A and the second ultrasound transceiving portion 20B. The receiving circuit portion 53 can, for example, be structured including an amplifying circuit for amplifying the signal with a prescribed gain, and a filter circuit for reading out an electric signal of a prescribed frequency. The receiving circuit portion 53, based on a control signal that is inputted from the calculating/controlling portion 55, amplifies and filters the electric signal outputted from the piezoelectric element 22 of either the first ultrasound transceiving portion 20A or the second ultrasound transceiving portion 20B, to convert into a received signal. The received signal that has been converted is outputted by the receiving circuit portion 53 to the calculating/controlling portion 55.

The clock portion 54 is for measuring time over a prescribed interval. The clock portion 54 may be structured from, for example, an oscillating circuit, or the like. Note that the oscillating circuit may be shared with that of the transmitting circuit portion 52. The clock portion 54 counts the number of reference waves of the oscillating circuit to measure time based on a start signal and a stop signal inputted from the calculating/controlling portion 55. The clock portion 54 outputs, to the calculating/controlling portion 55, the measured time.

The calculating/controlling portion 55 is that which performs calculations through calculating the flow rate of the gas that flows within the pipe A. The calculating/controlling portion 55 may be structured from, for example, a CPU, memory such as a ROM or a RAM, an input/output interface, and the like. Moreover, the calculating/controlling portion 55 controls the various portions of the main unit portion 50 such as the switching portion 51, the transmitting circuit portion 52, the receiving circuit portion 53, the clock portion 54, and the Inputting/outputting portion 56. Note that the method with which the calculating/controlling portion 55 calculates the flow rate of the gas will be described below.

The inputting/outputting portion 56 is for inputting information from the user and for outputting information to the user. The inputting/outputting portion 56 may be structured through, for example, inputting means such as operating buttons and outputting means such as a display. Various types of information, such as settings, are inputted into the calculating/controlling portion 55 through the inputting/outputting portion 56 through the operator operating the operating buttons, and the like. Moreover, the inputting/outputting portion 56 outputs information, such as the calculated airflow rate, gas speed, flow over a prescribed interval, and the like, through the calculating/controlling portion 55 displaying on the display.

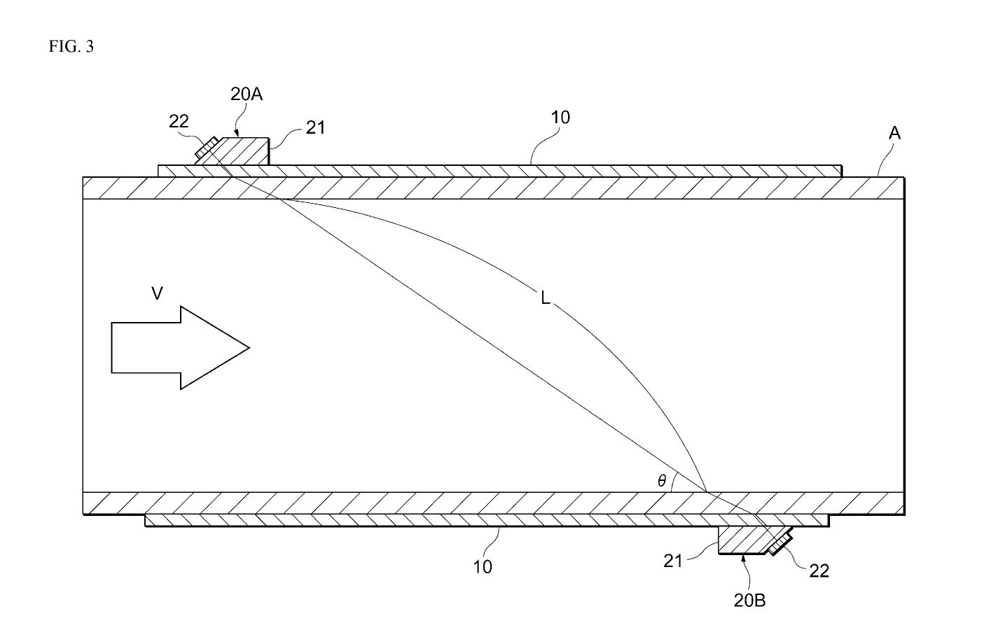

Here the method for calculating the flow rate of the gas that flows within the pipe A will be explained using FIG. 3. As illustrated in FIG. 3, the speed of the air that flows in a prescribed direction within the pipe A (the direction from the left to the right in FIG. 3) (where the speed is defined as the “flow speed,” below) is defined V (m/s), and the speed with which the ultrasound propagates within the air (hereinafter defined as the “speed of sound”) is defined as C (m/s), with the propagation path length of the ultrasound that propagates through the air defined as L (meters), and the angle formed by the axis of the pipe A and the ultrasound propagation path is defined as θ. Here the propagation time T₁2 for the ultrasound to propagate through the gas within the pipe A when the first ultrasound transceiving portion 20A, which is disposed on the upstream side of the pipe A (the side on the left in FIG. 3) transmits ultrasound and the second ultrasound transceiving portion 20B, which is disposed on the downstream side of the pipe A (the side on the right in FIG. 3) receives the ultrasound, is expressed by Equation (1), below:

t₁₂=L/(C+Vcosθ) (1)

On the other hand, the propagation time T₂₁ for the ultrasound to propagate through the gas within the pipe A when the second ultrasound transceiving portion 20B, which is disposed on the downstream side of the pipe A transmits ultrasound and the first ultrasound transceiving portion 20A, which is disposed on the upstream side of the pipe A receives the ultrasound, is expressed by Equation (2), below:

t₂₁=L/(C−Vcosθ) (2)

From Equation (1) and Equation (2), the flow speed V of the gas is expressed through Equation (3), below:

V=(L/2cosθ)·{(1/t12)−(1/t₂)} (3)

In Equation (3) the propagation path length L and angle θ are known values prior to measuring the flow rate, so the flow speed V can be calculated from Equation (3) through measuring the propagation time t₁₂ and the propagation time t₂₁.

Additionally, the flow rate Q (m³/s) of the gas that flows within the pipe A is expressed through the following Equation (4) using the flow speed V (m/s), a complement coefficient K, and the cross-sectional area S (m²) of the pipe A:

Q=KVS (4)

Consequently, the calculating/controlling portion 55 stores the propagation path length L, the angle θ, the complement coefficient K, and the cross-sectional area S of the pipe A in advance in memory, or the like. Given this, the calculating/controlling portion 55, by measuring the propagation time t₁₂ and the propagation time t₂₁, using the clock portion 54, is able to calculate the flow rate Q of the gas that flows within the pipe A using Equation (3) and Equation (4) based on the reception signal is inputted from the receiving circuit portion 53. That is, the calculating/controlling portion 55 functions as the flow rate calculating portion in the present invention.

In the form of calculation in the present example, an example is illustrated wherein the flow rate of the gas is calculated using an inverted propagation time difference method using FIG. and Equations (1) through (4); however, there is no limitation thereto. The calculating/controlling portion 55 may calculate the flow rate through another method instead, such as, for example, the well-known differential propagation time method.

Note that in FIG. 1 an example is illustrated wherein the first ultrasound transceiving portion 20A is disposed on the upstream side of the pipe A and the second ultrasound transceiving portion 20B is disposed on the downstream side of the pipe A, in FIG. 1, so as to cause the first ultrasound transceiving portion 20A and the second ultrasound transceiving portion 20B to mutually face each other, there is no limitation thereto. The first ultrasound transceiving portion 20A and the second ultrasound transceiving portion 20B need only be disposed on the outer peripheries of the upstream side and downstream side of the pipe A.

Moreover, while in the form of calculation in the present example, an example is shown wherein the ultrasound that is transmitted from the first ultrasound transceiving portion 20A and the second ultrasound transceiving portion 20B passes through the gas within the pipe A and is received directly by the other one of the first ultrasound transceiving portion 20A and the second ultrasound transceiving portion 20B, there is no limitation thereto. The ultrasound that propagates through the gas within the pipe A may be reflected by an inner wall of the pipe A. Consequently, the other one of the first ultrasound transceiving portion 20A and the second ultrasound transceiving portion 20B may instead receive the ultrasound that has been reflected 2n times (where n is a positive even number) by the inner walls of the pipe A.

Typically, “ultrasound” refers to sound waves in a frequency band of above 20 kHz. As a result, the ultrasound emitted from the first ultrasound transceiving portion 20A and from the second ultrasound transceiving portion 20B is ultrasound in a frequency band of above 20 kHz. Preferably, the ultrasound that is emitted by the first ultrasound transceiving portion 20A and the second ultrasound transceiving portion 20B is ultrasound in a frequency band that is above 100 kHz and below 2.0 MHz. More preferably, the ultrasound that is emitted by the first ultrasound transceiving portion 20A and the second ultrasound transceiving portion 20B is ultrasound in a frequency band that is above 0.5 MHz and below 1.0 MHz. Note that in any case, the ultrasound that is emitted from the first ultrasound transceiving portion 20A and the ultrasound that is emitted from the second ultrasound transceiving portion 20B may be of identical frequencies or may be of different frequencies.

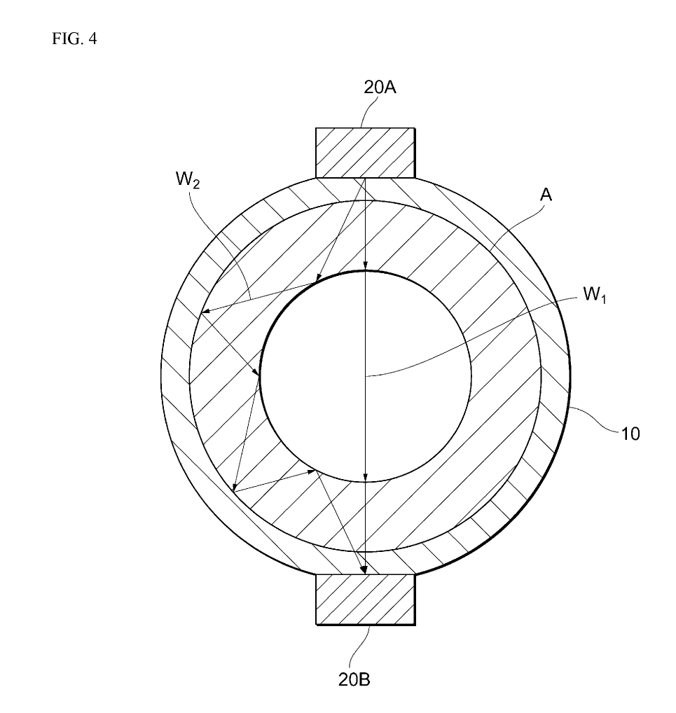

FIG. 4 is an cross-sectional diagram for explaining the state of reception, by a second ultrasound transceiving portion 20B, of ultrasound that is transmitted from the first ultrasound transceiving portion 20A. As illustrated in FIG. 4, for example, the ultrasound that is transmitted from the first ultrasound transceiving portion 20A is divided into the gas-propagated wave W₁ that passes through the pipe A to propagate within the gas within the pipe A, and the piping-propagated wave W₂ that is reflected by the pipe wall of the pipe A to propagate within the pipe A. The gas-propagated wave W₁ passes again through the pipe A to arrive at the second ultrasound transceiving portion 20B. On the other hand, the piping-propagated wave W₂ also arrives at the second ultrasound transceiving portion 20B while reflecting multiple times from the inner wall and the outer wall of the pipe A. While diagrams and explanations of details thereof are omitted, the ultrasound that is transmitted from the second ultrasound transceiving portion 20B is also divided into an gas-propagated wave W₁ and a piping-propagated wave W₂, in the same manner as the ultrasound that is transmitted by the first ultrasound transceiving portion 20A, where the gas-propagated wave W₁ passes through the pipe A to arrive at the first ultrasound transceiving portion 20A, and the piping-propagated wave W₂ can also arrive at the first ultrasound transceiving portion 20A while reflecting multiple times on the inner wall and the outer wall of the pipe A.

Typically whether the sound waves that propagate through one of the media are transmitted (pass-through) the interface with the other medium or are reflected thereby is determined by the difference in the acoustic impedances of the one medium and the other medium. That is, the smaller the difference in acoustic impedances, the greater the tendency for transmission of the sound waves that are propagating through one pipe medium that will be transmitted into the other medium, and the greater the difference in acoustic impedances, the greater the tendency for the sound waves that are propagating within the one pipe medium to be reflected at the interface with the other medium.

If the fluid that is flowing within the pipe A is, for example, a liquid, the difference between the acoustic impedance of the liquid and the acoustic impedance of the piping material, such as a metal such as stainless steel (SUS) or a polymer compound, such as a synthetic resin, will be relatively small, so that the proportion of the ultrasound that passes through the pipe A to propagate through the liquid that is flowing therein (the “transmissivity”) will be high, that is, the proportion that is reflected by the pipe walls of the pipe A (the “reflectivity”) will be low, and thus the energy (magnitude or strength) of the piping-propagated wave W₂ will be small. On the other hand, the acoustic impedance of gas is small when compared to the acoustic impedance of a liquid. because of this, when the fluid that flows within the pipe A is gas, the difference between the acoustic impedance of the gas and the acoustic impedance of the pipe A will be relatively large, and thus the proportion of the ultrasound that passes through the pipe A to propagate within the gas that flows there within (the transmissivity) will be low, that is, the proportion that is reflected by the pipe wall of the pipe A will be large, and the energy (the magnitude or strength) of the piping-propagated wave W₂ will be large.

Here, in an ultrasonic flowmeter wherein the gas-propagated wave W₁ of the ultrasound is received, the propagation time is measured, and the flow rate is measured based on the propagation time, the gas-propagated wave W₁ is the signal (signal component) that is to be detected, where the piping-propagated wave W₂ is noise (noise component) relative to the signal. In the present invention, an ultrasound absorbing body 10 is provided on the outer peripheral surface of the pipe A, as illustrated in FIG. 1 through FIG. 4, in order to suppress the piping-propagated wave W₂ that is such a noise component.

The ultrasound absorbing body 10 is disposed so as to cover a region of the outer peripheral surface of the pipe A between the first ultrasound transceiving portion 20A and the second ultrasound transceiving portion 20B, and secured in intimate contact with the outer peripheral surface of the pipe A. In the present invention, as illustrated in FIG. 4, the ultrasound absorbing body 10 is disposed also between the first ultrasound transceiving portion 20A (second ultrasound transceiving portion 20B) and the pipe A. Given this, in a state wherein the ultrasound absorbing body 10 is disposed in this way between the first ultrasound transceiving portion 20A (the second ultrasound transceiving portion 20B) and the pipe A, a securing member, not shown, is used to apply a pressing force in the direction of the pipe A from the outside of the first ultrasound transceiving portion 20A (the second ultrasound transceiving portion 20B), to secure by pressing the first ultrasound transceiving portion 20A (the second ultrasound transceiving portion 20B) against the pipe A with the ultrasound absorbing body 10 interposed therebetween.

The function that attenuates the piping-propagated wave W₂ is produced through the ultrasound absorbing body 10. On the other hand, through disposing the ultrasound absorbing body 10 in between and in opposition to the pipe A and the first ultrasound transceiving portion 20A (the second ultrasound transceiving portion 20B), the air-propagated wave W₁ is allowed to propagate. In the present example, the ultrasound absorbing body 10 is disposed between the first ultrasound transceiving portion 20A (the second ultrasound transceiving portion 20B) and the pipe A instead of the couplant material that is employed conventionally, in order to effectively take advantage of the performance of this type of ultrasound absorbing body 10.

In the present example, an ultrasound absorbing body 10 that includes an easily handles material that has relatively high ultrasound transmission performance (for example, non-cross linked butyl rubber, silicone rubber, or the like) is used. Moreover, in order to cause the acoustic impedance of the ultrasound absorbing body 10 to be near to the acoustic impedance of the pipe A, a high-density particulate material (for example, particles of a metal such as tungsten, particles of an organic compound that includes ferrite, particles of an inorganic compound such as barium sulfate, iron oxide, or alumina, or the like) can be mixed into the ultrasound absorbing body 10.

The method for attaching the ultrasonic flowmeter 1 according to an example according to the present invention will be explained next.

First the first ultrasound transceiving portion 20A, second ultrasound transceiving portion 20B, and ultrasound absorbing body 10, which structure the ultrasonic flowmeter 1, are prepared, and the ultrasound absorbing body 10 that is disposed between the first ultrasound transceiving portion 20A (the second ultrasound transceiving portion 20B) and the pipe A (a placing step). Note that in this placing step, the ultrasound absorbing body 10 is disposed so as to cover at least a region of the outer peripheral surface of the pipe A that is between the first ultrasound transceiving portion 20A and the second ultrasound transceiving portion 20B, rather than only a region between the first ultrasound transceiving portion 20A (the second ultrasound transceiving portion 20B) and the pipe A.

Following this, a securing member, not shown, is used to apply a pressing force toward the pipe A from the outside of the first ultrasound transceiving portion 20A (the second ultrasound transceiving portion 20B), so as to secure through pushing the first ultrasound transceiving portion 20A (the second ultrasound transceiving portion 20B) against the pipe A with the ultrasound absorbing body 10 interposed therebetween (a pressing step). A clamp-type securing member that applies a pressing force through causing a pair of holding portions, which are disposed at positions facing each other with the pipe A held therebetween, to move toward each other at the pipe A side, may be employed as the securing member. The torque that is applied by the clamp-type securing member can be set to, for example, about 100 cN·m.

In the ultrasonic flowmeter 1 according to the example explained above, the application of the pressing force in the direction of the pipe A from the outside of the first ultrasound transceiving portion 20A (the second ultrasound transceiving portion 20B) in a state wherein the ultrasound absorbing member 10 is disposed between the first ultrasound transceiving portion 20A (the second ultrasound transceiving portion 20B) and the pipe A makes it possible to secure the first ultrasound transceiving portion 20A (the second ultrasound transceiving portion 20B) to the pipe A with the ultrasound absorbing body 10 interposed therebetween. This makes it possible to eliminate the complex operation, which has been required conventionally, when securing the first ultrasound transceiving portion 20A (the second ultrasound transceiving portion 20B) to the pipe A (such as, for example, an operation for cutting away a portion of the ultrasound absorbing body 10, an operation for coating the cut part with a couplant material, and the like), thus making the operations for attaching, and removing and adjusting, the first ultrasound transceiving portion 20A (the second ultrasound transceiving portion 20B) substantially easier. As a result, the benefits of the clamp-on ultrasonic flowmeter 1, wherein there is no need, for example, to cut the pipe A, are no longer canceled out. Moreover, this makes it possible to eliminate the complex operation is that have been required conventionally when securing the first ultrasound transceiving portion 20A (the second ultrasound transceiving portion 20B) to the pipe A, thus enabling even attachment to a pipe that is disposed near the ceiling to be carried out safely. Furthermore, while sometimes, when a couplant material is used, the signal strength may vary depending on the amount of the coating, there is no need for a coating with a couplant material when the attaching method according to the present example is used, thus enabling a contribution to the stability of the signal strength.

Moreover, because in the ultrasonic flowmeter 1 according to the example explained above an ultrasound absorbing body 10 that includes an easily handled material (for example, and non-cross linked butyl rubber or silicone rubber) is employed, the attaching operation is substantially easier. Furthermore, the propagation performance in the present invention can be achieved through the non-cross-linked butyl rubber or silicone rubber, making it possible to produce a signal strength that is in no wise inferior to that of the case wherein the couplant agent is employed.

The present invention is not limited to the examples set forth above, but rather appropriate design changes to these examples by those skilled in the art are included in the scope of the present invention insofar as they are provided with the distinctive characteristics thereof. That is, the various elements, positioning, materials, conditions, shapes, sizes, and the like provided in the examples set forth above are not limited to those illustrated, but rather may be changed as appropriate. Moreover, the various elements provided in the examples set forth above may be combined insofar as it is technically possible, and these combinations are included in the scope of the present invention insofar as they include the distinctive features of the present invention.

1. A method for attaching an ultrasonic flowmeter that comprises:
a first ultrasound transceiving portion for carrying out transmission and reception of ultrasound, provided on an outer periphery of an upstream side of piping wherein a fluid is flowing;
a second ultrasound transceiving portion for carrying out transmission and reception of ultrasound, provided on an outer periphery of a downstream side of the piping;
a flow rate calculating portion for calculating a flow rate of the fluid based on a time until the reception, by the second ultrasound transceiving portion, of the ultrasound transmitted by the first ultrasound transceiving portion and a time until the reception, by the first ultrasound transceiving portion, of the ultrasound transmitted by the second ultrasound transceiving portion; and
an ultrasound absorbing body for absorbing a piping-propagated wave of the ultrasound, provided on an outer periphery of the piping, the method comprising:
a placing step for disposing the ultrasound absorbing body between the ultrasound transceiving portion and a pipe; and
a pressing step for pressing the ultrasound transceiving portion against the pipe, with the ultrasound absorbing body interposed therebetween, through an application of a pressing force toward the pipe from outside of the ultrasound transceiving portion.

2. An ultrasonic flowmeter comprising:
a first ultrasound transceiving portion that carries out transmission and reception of ultrasound, provided on an outer periphery of an upstream side of piping wherein a fluid is flowing;
a second ultrasound transceiving portion that carries out transmission and reception of ultrasound, provided on an outer periphery of a downstream side of the piping;
a flow rate calculating portion that calculates a flow rate of the fluid based on a time until the reception, by the second ultrasound transceiving portion, of the ultrasound transmitted by the first ultrasound transceiving portion and a time until the reception, by the first ultrasound transceiving portion, of the ultrasound transmitted by the second ultrasound transceiving portion; and
an ultrasound absorbing body that absorbs a piping-propagated wave of the ultrasound, provided on an outer periphery of the piping, wherein:
the ultrasound transceiving portion is secured through being pressed against a pipe, with the ultrasound absorbing body interposed therebetween, through an application of a pressing force, toward the pipe, from outside of the ultrasound transceiving portion, in a state wherein the ultrasound absorbing body is disposed between the ultrasound transceiving portion and the pipe.

3. The ultrasonic flowmeter as set forth in claim 2, wherein: the ultrasound absorbing body includes a non-cross-linked butyl rubber or a silicone rubber.
